(19) United States
(12) Patent Application Publication
(10) Pub. No.: US 2015/0218865 A1
(43) Pub. Date: Aug. 6, 2015

(54) CANTILEVERED BI-FOLD DOOR SUPPORT

(71) Applicant: FRANKLIN D. RASMUSSEN, WEST BEND, WI (US)

(72) Inventor: FRANKLIN D. RASMUSSEN, WEST BEND, WI (US)

(73) Assignee: CUSTOM SERVICE HARDWARE, INC., CEDARBURG, WI (US)

(21) Appl. No.: 14/612,668

(22) Filed: Feb. 3, 2015

Related U.S. Application Data
(60) Provisional application No. 61/935,609, filed on Feb. 4, 2014.

(51) Int. Cl. E05D 13/00; E05F 11/08; E05F 17/00

(52) U.S. Cl. CPC E05D 13/00; E05F 17/00; E05F 11/08; E05F 2017/007; E05Y 2900/132

(57) ABSTRACT

Systems and methods according to the present invention relate generally to hardware, and more specifically to door guiding hardware. Cantilevered mounting brackets are provided to interface with a track, which may be mounted to a vertical support surface such as a wall or doorway. One of the brackets is stationarily mounted with respect to the track and the other includes a bearing that is movable in and guided by the track. The brackets are suited for affixation to a multi-panel door, such as a bi-fold door.

### RELATED APPLICATIONS

This application claims the benefit of co-pending U.S. Provisional Patent Application Ser. No. 61/935,609, filed on 5 Feb. 2014, and titled “Cantilevered Bi-Fold Door Support.”

### BACKGROUND OF THE INVENTION

At times it may be desirable to conceal the existence of room or other space by use of a disguised door or passageway. For example, a homeowner may wish to create a safe room wherein the doorway is disguised to thereby deceive a casual viewer of its existence. Such doorway disguise may be in the form of a bookcase or other large furniture item that conceals the passageway to such a room. Such passageway closure disguise may conceal any number of spaces, such as those containing a safe or other valuables, private areas, or novelty rooms. The passageway closure of such spaces and others may include the use of bi-fold doors. A typical bi-fold door may included require a valance member to support a mounting track immediately above the door for supporting the door in a closed position. Moreover, known arrangements such as these can be costly and inflexible in design. Embodiments according to the present invention relate to passageway closures, and more specifically to an improved guide system for a bi-fold door that does not require use of a valance.

### SUMMARY OF THE INVENTION

The present invention relates to an improved guide system for a hinged door having a plurality of panel sections, such as a bi-fold door. The guide system may include a cantilevered pivot assembly, a cantilevered slide assembly and a top track. The cantilevered pivot assembly may further include a door mounting bracket adapted to be fixedly secured to a top surface of one of the panel sections. The cantilevered pivot assembly may further include a support bracket rotatably coupled to the mounting bracket at a pivot point. A track mounting bracket may also be provided on the cantilevered pivot assembly. The present guide system provides installation flexibility and eliminates the need of a costly valance.

### BRIEF DESCRIPTION OF THE DRAWINGS

FIG. 1 is a front elevation view of an embodiment of a prior bi-fold door arrangement.

FIG. 2 is a first perspective, partial assembly view of the embodiment of FIG. 1.

FIG. 3 is a second perspective, partial assembly view of the embodiment of FIG. 1.

FIG. 4 is a front elevation view of an embodiment of a bi-fold door including a support mechanism according to the present invention.

FIG. 5 is a perspective, partial assembly view of the embodiment of FIG. 4.

FIG. 6 is a perspective view of an embodiment of a pivot assembly according to the present invention.

FIG. 7 is a perspective view of an embodiment of a slide assembly according to the present invention.

FIG. 8 is a perspective view of an embodiment of a guide track according to the present invention.

FIG. 9 is a right end view of the assembly of FIG. 6 interfacing the track of FIG. 8.

FIG. 10A is a top plan view of the embodiment of FIG. 3, with the door in the open position.

FIG. 10B is a view similar to that of FIG. 10A, but showing the door and relative movement of the parts as it moves to the closed position.

FIG. 10C is a view similar to that of FIGS. 10A and 10C, but showing the door in the closed position.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

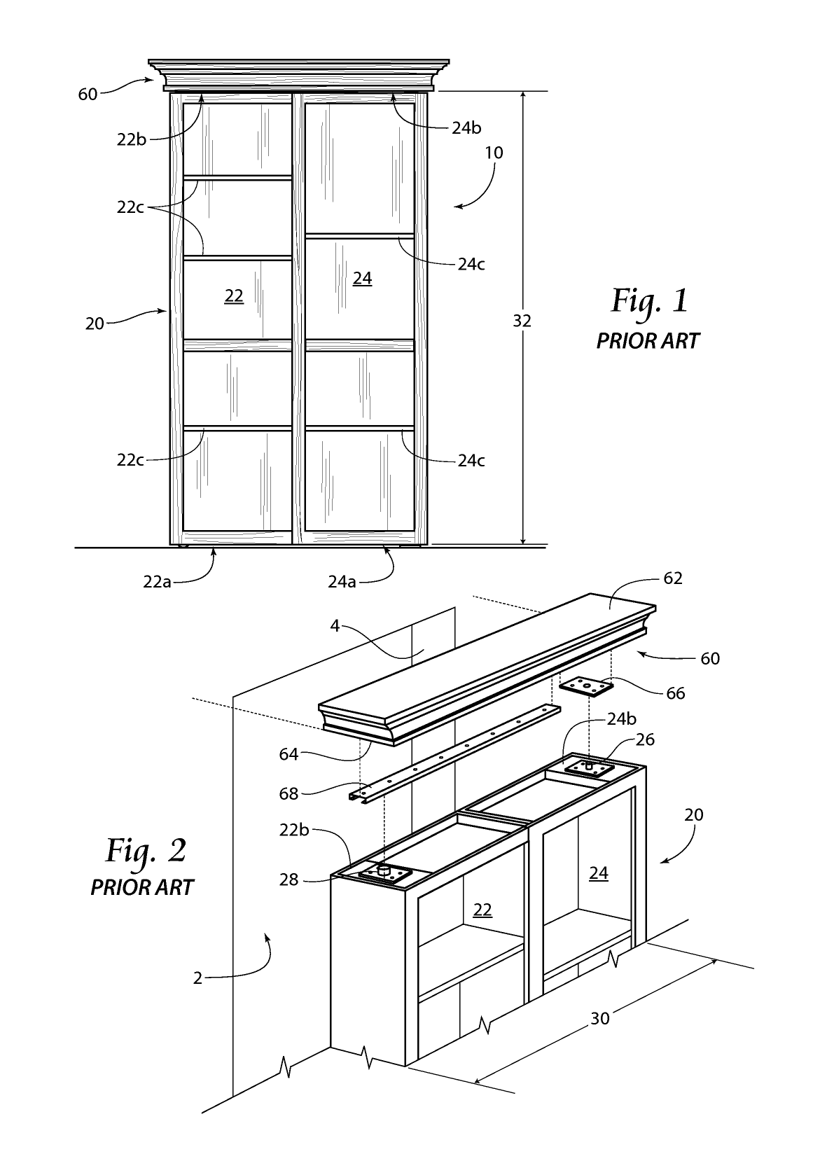

With reference now to FIGS. 1-3, a prior art bi-fold door system 10 may be seen. Generally, the prior art system 10 includes a door 20 and a valance 60. The door 20 has a first panel section 22 and a second panel section 24, joined along a hinged juncture. The first panel section 22 extends from a bottom end 22a to a top end 22b, through a height 32. The first panel section 22 may further include a plurality of shelves 22c, which may be adjustable at various positions along the height 32. The second panel section 24 extends from a bottom end 24a to a top end 24b, through the height 32. The second panel section 24 may further include a plurality of shelves 24c, which may be adjustable at various positions along the height 32. The door 20 is adapted to be positioned in front of a passageway or doorway 2, so as to obscure same. Thus a combined width 30 (of the first panel section 22 and the second panel section 24) and the height 32 are preferably dimensioned to be at least as wide and high, respectively, as the dimensions of the passageway 2, and more preferably larger than the dimensions of the passageway 2. For guiding purposes, each panel section 22, 24 is provided with hardware. As shown in FIG. 2, a pivot pin 26 is mounted to the top surface 24b of the second panel section 24, extending vertically upward therefrom. A bearing 28 is mounted to the top surface 22b of the first panel section 22, extending vertically upward therefrom.

The valance 60 generally has a top surface 62 and a bottom surface 64. The bottom surface 64 generally supports hardware to interface with the hardware mounted to the door 20. A pivot plate 66 is stationarily mounted to the bottom surface 64 of the valance 60. The pivot plate 66 provides a rotational bearing surface that accepts the pivot pin 26, allowing rotation thereof. A guide track 68 is also stationarily mounted to the bottom surface 64 of the valence 60, generally in longitudinal alignment with the pivot plate 66. The guide track 68 receives the bearing 28 in sliding or rolling engagement to allow movement of the bearing 28 along the track 68.

FIG. 3 shows a prior art bottom guide arrangement for use with the prior art bi-fold door system 10 illustrated in FIGS. 1 and 2. As shown, a pivot plate 82 may be securely fastened to the bottom surface 24a of the second panel section 24. The pivot plate 82 provides a rotational bearing surface (e.g. a hole) which is adapted to accept a pivot pin 84, which may be fixedly attached to a floor. A bottom track 86 is affixed to the floor, generally in longitudinal alignment with the pivot pin, and a caster plate 88 is secured to the bottom surface 22a of the first panel section 22. A caster wheel 90 is coupled to and at least indirectly rotatably supported in a vertical plane by the caster plate 88. The caster wheel 90 is also at least indirectly rotatably supported in a horizontal plane by the caster plate 88. The caster wheel 90 is adapted to interface with the bottom track 86, preferably including a circumferential surface having a cross-section which mates with a cross-section of the track 86. For example, the track 86 may be provided with a raised, partially cylindrical upper guide surface and the wheel 90 may have a groove adapted to follow such guide surface to allow longitudinal translation of the wheel 90 along the track 88.

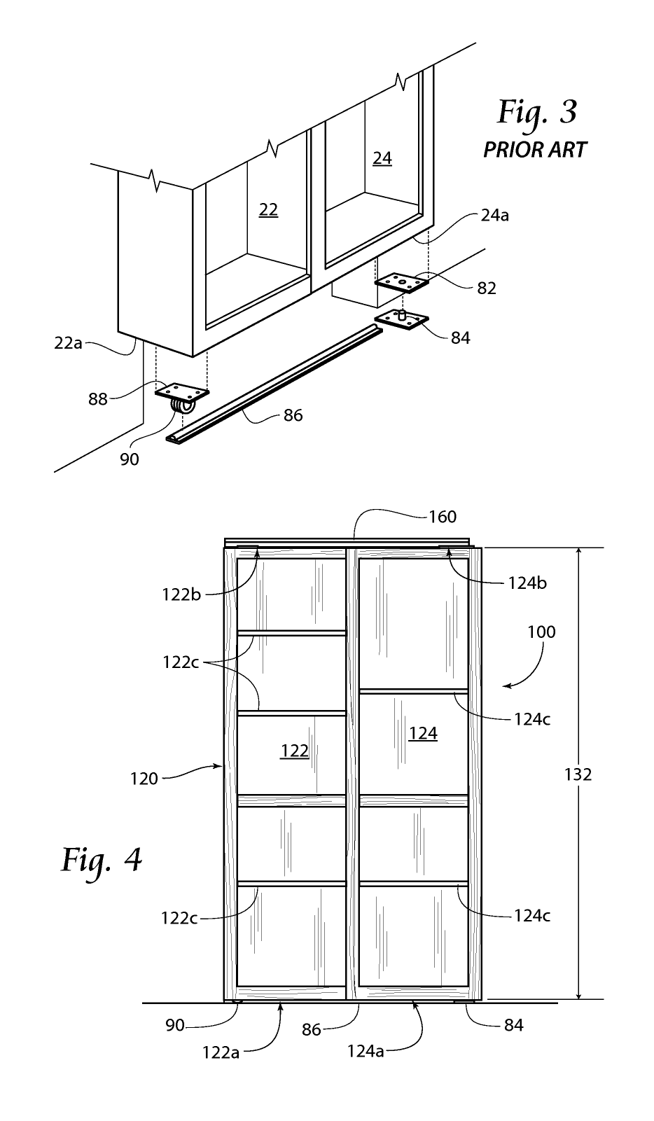

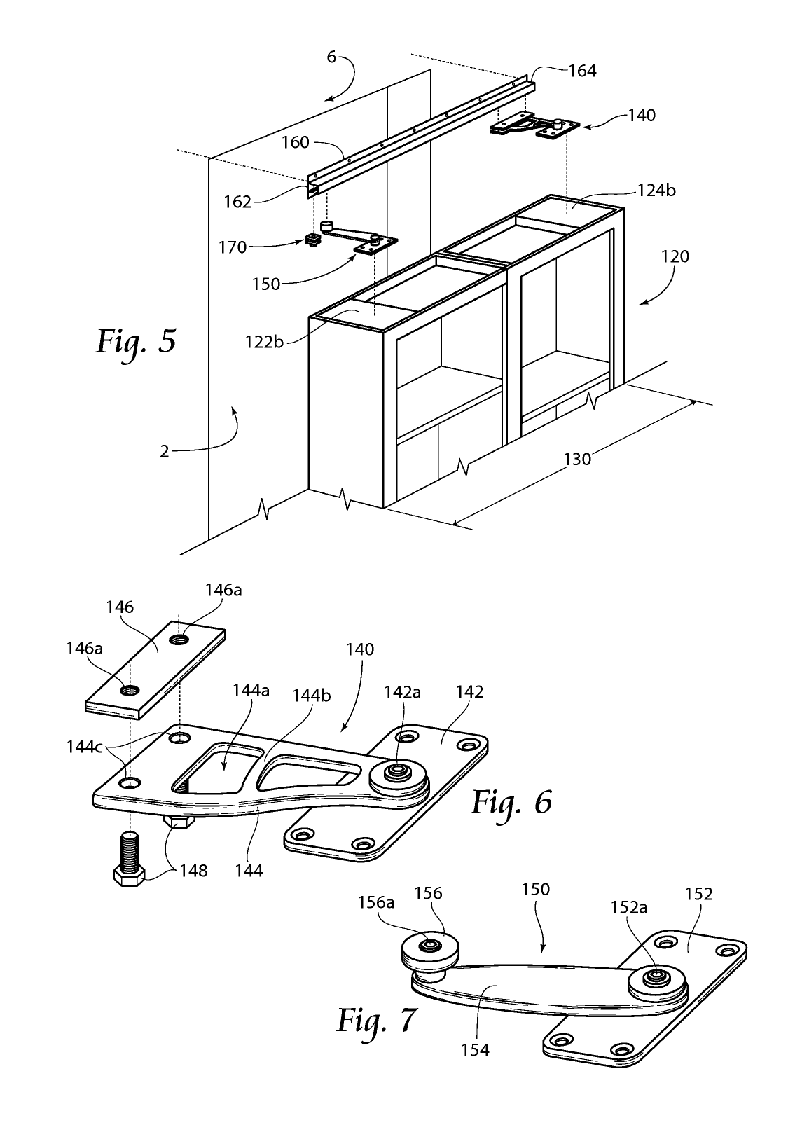

Turning now to FIGS. 4 and 5, an embodiment of a bi-fold door system 100 according to the present invention may be introduced. Similar to the prior art system 10, described above, the door system 100 according to the present application includes a door member 120. The door 120 has a first panel section 122 and a second panel section 124, joined along a hinged juncture. The first panel section 122 extends from a bottom end 122a to a top end 122b, through a height 132. The first panel section 122 may further include a plurality of shelves 122c, which may be adjustable at various positions along the height 132. The second panel section 124 extends from a bottom end 124a to a top end 124b, through the height 132. The second panel section 124 may further include a plurality of shelves 124c, which may be adjustable at various positions along the height 132. The door 120 is adapted to be positioned in front of a passageway or doorway 2, so as to obscure same. Thus a combined width 130 (of the first panel section 122 and the second panel section 124) and the height 132 are preferably dimensioned to be at least as wide and high, respectively, as the dimensions of the passageway 2, and more preferably larger than the dimensions of the passageway 2. A bottom guide arrangement that is substantially similar to that shown in FIG. 3, and previously described, may be used in conjunction with an embodiment of a bi-fold door system 100 including cantilevered guides according to the present invention, as will be discussed.

For guiding the top of the door 120, each panel section 122, 124 is provided with novel hardware, including one or more of a cantilevered pivot assembly 140, a cantilevered slide assembly 150 and a top track 160. FIG. 6 shows an embodiment of the cantilevered pivot assembly 140. As seen, the assembly 140 preferably includes a door mounting bracket 142 adapted to be fixedly secured to the top surface 122b or 124b of one of the panel sections 122, 124. The assembly 140 further includes a support bracket 144 rotatably coupled to the mounting bracket 142 at a pivot point 142a. The bracket 144 may include one or more openings 144a and/or support members 144b to strengthen such openings 144a. A track mounting bracket 146 is also provided on the assembly 140. The track mounting bracket 146 may be coupled to the support bracket 144, in a spaced relationship therefrom, by one or more threaded fasteners 148 cooperating with threaded apertures 146a formed in the bracket 146. The spaced coupling of the track mounting bracket to the support bracket 144 allows for interface with and securement to a stationary track 160, as is further described below.

FIG. 7 shows an embodiment of a cantilevered slide assembly 150 for use with the present invention. The assembly 150 includes a door mounting bracket 152 adapted to be fixedly secured to the other top surface 124b or 122b of one of the panel sections 124, 122. The assembly 150 further includes a support bracket 154 rotatably coupled to the mounting bracket 152 at a pivot point 152a. A bearing member 156 is also provided on the assembly 150. The bearing 156 may be coupled to the support bracket 154 by one or more threaded fasteners 156a cooperating with a threaded aperture formed in the bracket 154. The bearing 156 may be stationarily secured to the support bracket 154 to slide within the track 160, or rotatably supported thereby (e.g. a ball bearing arrangement) to reduce sliding friction.

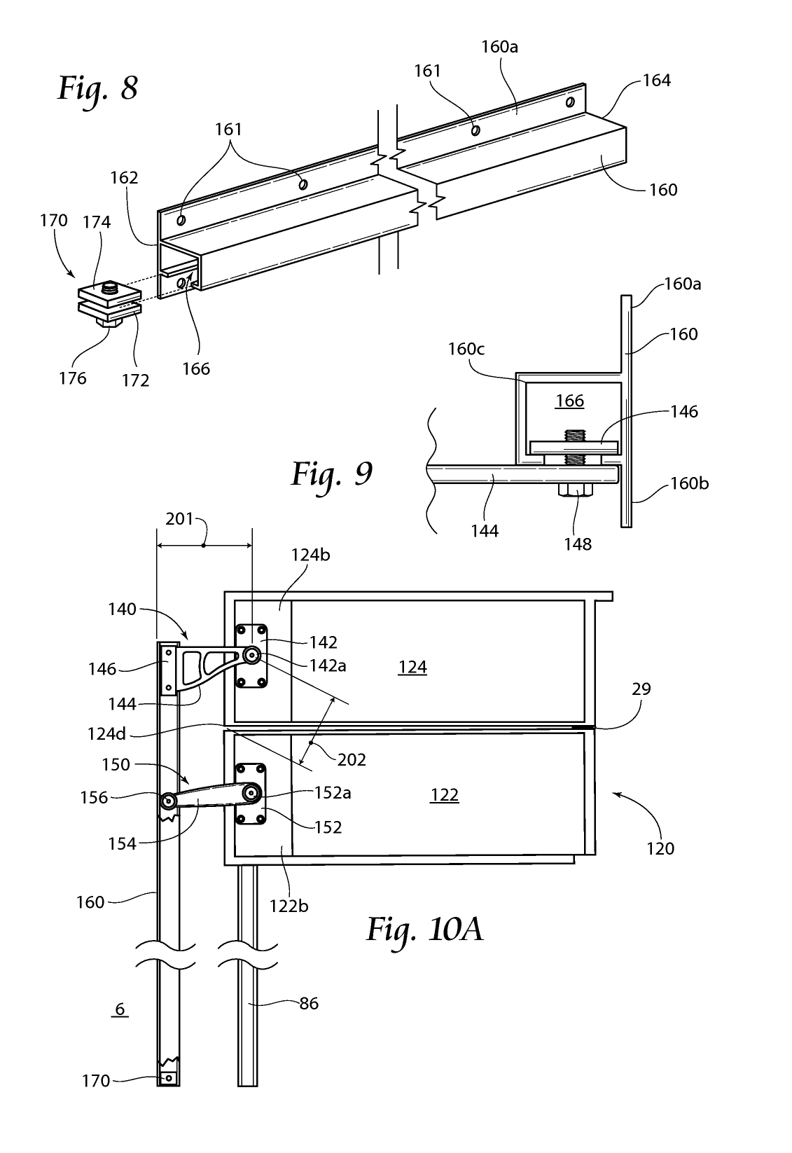

With attention now to FIGS. 8 and 9, an embodiment of a top track 160 for use with the present invention may be seen. As illustrated, the top track 160 is a substantially longitudinal member extending between a first end 162 and a second end 164. A channel 166 is preferably defined by a channel sidewall 160c extending between and including the first end 162 and the second end 164. The ends of the channel 166 are preferably open, but may be capped after installation of the bearing 156, track mounting bracket 146, and/or an end stop assembly 170. The end stop assembly 170 has a bottom plate 172 and a top plate 174 coupled to the bottom plate 172 in a spaced relationship by, e.g., a threaded fastener 176. The end stop assembly 170 may be secured within the channel 166, at one of the track ends 162,164 or between one of the track ends 162 or 164 and the bearing 156.

FIG. 9 shows an interface between the pivot assembly 140 and the track 160 according to the present invention. As can be seen, the track mounting bracket 146 is inserted at least partially, but preferably completely, into the channel 166 in the track 160. Threaded fasteners 148 may then be inserted through the support bracket 144 to engage the track bracket 146 and, when tightened, secure the mounting bracket 144 to the track 160. Also inserted into the channel 166 is the bearing 156 (not seen in this view).

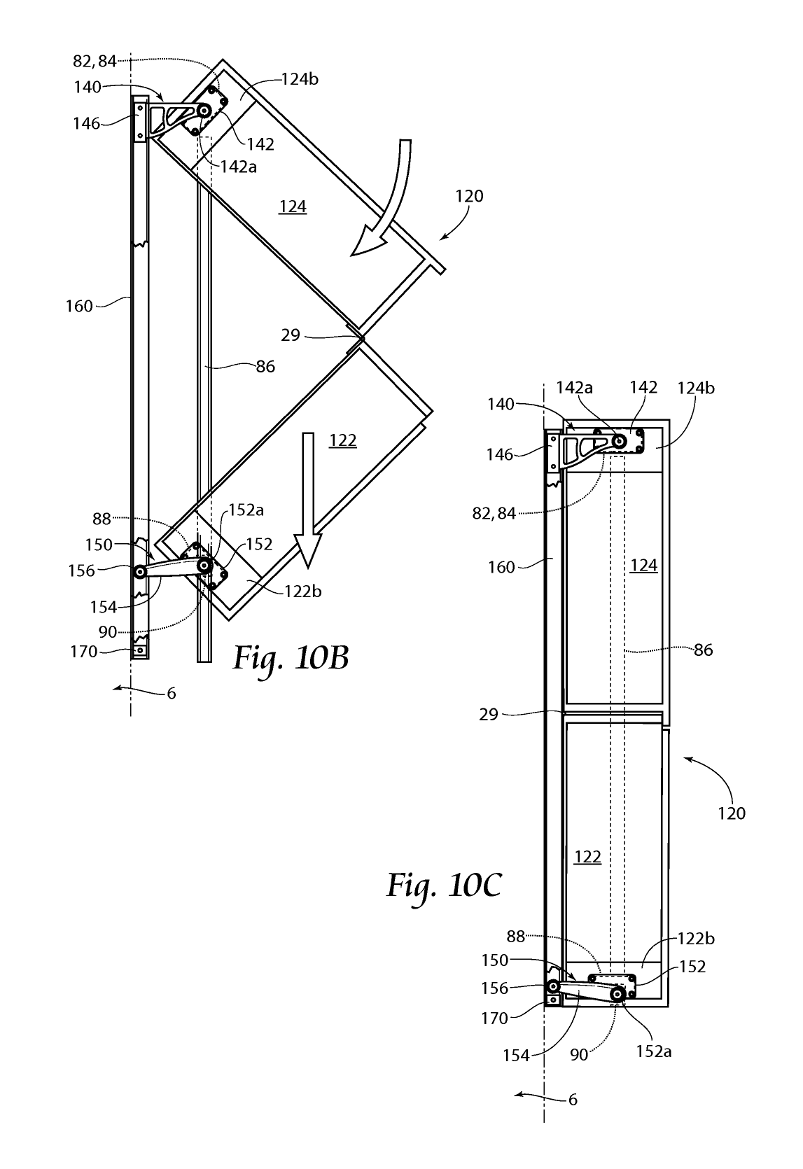

With reference now to FIGS. 10A-10C, movement of the door 120 after installation may be seen. As illustrated, the track mounting bracket 146 is secured to the track 160 (which is preferably secured to a wall 6 just above a passageway 2), the bearing 156 disposed within the track channel 166, and the end stop assembly 170 is also secured to the track 160. In operation, substantially all of the weight of the door 120 is preferably supported by the bottom (such as bottom surfaces 122a, 124a). The pivot assembly 140 provides a pivot point 142a for the second panel section 124, and the slide assembly 150 provides a guide interface with the track 160 to enable the first section 122 to pivot on the hinge 29 and slide to close the passageway 2. Dimensionally, the pivot point 142a is preferably stationarily fixed at a first distance 201 from the wall 6. That first distance 201 is preferably greater than a second distance 202, measured from the pivot point 142a to a right rear corner 124d of the second panel section 124 so as to provide clearance for such corner 124d during operation. In this fashion, a guide mechanism is provided including brackets that are cantilevered, extending radially outwardly beyond the edge of the top surface(s) of the door, thereby allowing for wall mounting of a track member, rather than requiring the mounting of a track immediately above the door when the door is in a closed position. This arrangement provides for great installation flexibility and eliminates the need of a costly valence.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims. For instance, while depicted as opening from left to right, the cantilevered assemblies 140, 150 may be swapped, such that the cantilevered pivot assembly 140 is on the first panel section 122 and the cantilevered slide assembly 150 is on the second panel section 124 so that the door 120 would open from right to left.

I/We claim:

1. A bi-fold door system for obscuring a passageway including:
a door member, said door member having a first panel section and a second panel section, said first panel section and said second panel section being joined along a hinged juncture;
said first panel section extends from a first panel bottom end to a first panel top end, through a height;
said second panel section extends from a second panel bottom end to a second panel top end, through the height;
a cantilevered pivot assembly;
a cantilevered slide assembly; and
a top track.

2. The assembly of claim 1 wherein said cantilevered pivot assembly includes a first door mounting bracket arranged to be fixedly secured to a top surface of one of said first panel section and second panel section.

3. The assembly of claim 2 wherein said cantilevered pivot assembly further includes a pivot support bracket rotatably coupled to said first door mounting bracket at a pivot point.

4. The assembly of claim 3 wherein said pivot support bracket includes at least one opening and at least one support member.

5. The assembly of claim 3 wherein said cantilevered pivot assembly further includes a track mounting bracket, said track mounting bracket being coupled to said pivot support bracket.

6. The assembly of claim 2 wherein said cantilevered slide assembly includes a second door mounting bracket arranged to be fixedly secured to a top surface of the other of said first panel section and second panel section.

7. The assembly of claim 6 wherein said cantilevered slide assembly further includes a slide assembly support bracket rotatably coupled to said second door mounting bracket at a pivot point.

8. The assembly of claim 7 wherein said cantilevered slide assembly further includes a bearing member, said bearing member being coupled to said slide assembly support bracket.

9. The assembly of claim 8 wherein said top track includes:
a longitudinal member extending between a track first end and a track second end;
a channel, defined by a channel sidewall extending between and including said first end and said second end; and
an end stop assembly.

10. The assembly of claim 9 wherein said bearing member is configured to ride in said channel.

11. The assembly of claim 9 wherein said end stop assembly includes a bottom plate and a top plate coupled to said bottom plate in a spaced relationship.

12. The assembly of claim 11 wherein said end stop assembly is secured within said channel at one of said track first end and said track second end.

13. The assembly of claim 11 wherein said end stop assembly is secured within said channel between a selected track end and said bearing member.

14. The assembly of claim 1 wherein at least one of said first panel section and said second panel section includes at least one shelf member.

15. The assembly of claim 14 wherein said at least one shelf member is adjustable at various positions along said height.

16. The assembly of claim 1 further including a bottom guide assembly, said bottom guide assembly including:
a pivot plate fastened to a bottom surface of one of said first panel section and said second panel section, said pivot plate providing a rotational bearing surface configured to accept a pivot pin;
a bottom track arranged in longitudinal alignment with said pivot pin;
a caster plate fastened to a bottom surface of the other one of said first panel section and said second panel section; and
a caster wheel coupled to and at least indirectly rotatably supported in a vertical plane by said caster plate, said caster wheel further arranged d to interface with said bottom track, and including a circumferential surface having a cross-section which mates with a cross-section of said track.
